(19) United States
(12) Patent Application Publication
(10) Pub. No.: US 2006/0176418 A1
(43) Pub. Date: Aug. 10, 2006

(54) Apparatus and method for mounting interactive unit to flat panel display

(75) Inventors: Brent Anderson, Portland, OR (US); Aaron R. Friedman, Portland, OR (US); James D. Watson, Duluth, GA (US); Neal A. Hofmann, Portland, OR (US); Richard Meissner, Newberg, OR (US)

Correspondence Address: QUARLES & BRADY LLP, 411 E. WISCONSIN AVENUE, SUITE 2040, MILWAUKEE, WI, 53202-4497, US

(73) Assignee: PolyVision Corporation

(21) Appl. No.: 11/347,125

(22) Filed: Feb. 3, 2006

Related U.S. Application Data
(60) Provisional application No. 60/650,268, filed on Feb. 4, 2005.

(51) Int. Cl. G02F 1/1333

(52) U.S. Cl. 349/58

(57) ABSTRACT

A method and apparatus for mounting a sensor module adjacent the edge of a display including a housing wherein the housing forms at least a first mounting surface, the apparatus including a first coupler, a first adhesive layer securing the first coupler to the first mounting surface and a second coupler linked to the sensor module and coupled to the first coupler wherein the second coupler is adjustable to modify the relative position of the sensor module to the display unit.

### CROSS-REFERENCE TO RELATED APPLICATIONS

This application is related to U.S. Provisional Patent Application Ser. No. 60/650,268 which was filed on Feb. 4, 2005 and which is entitled “APPARATUS AND METHOD FOR MOUNTING INTERACTIVE UNIT TO FLAT PANEL DISPLAY.”

### STATEMENT REGARDING FEDERALLY SPONSORED RESEARCH OR DEVELOPMENT

Not applicable.

### BACKGROUND OF THE INVENTION

The costs associated with manufacturing flat panel displays have been decreasing appreciably recently which has made flat panel displays in general almost ubiquitous. For instance, many flat panel displays have been purchased to operate as televisions while others have been purchased to operate as display screens for conference rooms or the like where the displays are driven by standard PC or other types of software so that users can view a common display for sharing information.

In some cases flat panel displays have been configured for interactive use. For instance, one type of interactive assembly may include a large (e.g., 25-200 inch diagonal) flat panel display screen (e.g., plasma, LCD, etc.) mounted to a conference room wall for presenting information, a sensor system for sensing activity intended by a user to interact with the display and a drive unit for altering the displayed information as a function of user activities. For example, with a browser screen including screen selectable icons presented via the display screen, a user may employ a pen or stylus type device to select icons or place marks on the display screen (e.g., circle an item on the browser screen to highlight). In this case, the sensor system may be designed and programmed to sense pen activity and identify tip location with respect to the display surface and then to affect an intended result (e.g., draw a circle or line, select an associated icon, etc.). Many different types of sensing configurations for determining pen tip location are known including, for instance, laser sensors, cameras, RF sensors, IR sensors, etc.

While many flat panel displays for general purposes (e.g., as TV monitors, as common PC output devices, etc.) have been purchased, far fewer interactive displays have been purchased. The lack of interactive assembly purchases is primarily due to the added costs associated with the sensing and driving components required to configure such interactive assemblies. Here, costs of interactive assemblies are exacerbated where different display screen sizes (e.g., 25-200 inch diagonal) need to be supported and different sizes require different component configurations as well as size specific commissioning procedures (e.g., different sensor placements and alignment/commissioning procedures).

One other impediment to interactive assemblies has been that the additional component costs are often viewed as sunk costs that are lost as soon as the displays associated therewith become obsolete. Thus, for instance, where an interactive system surrounds a display bezel and the display becomes obsolete four years after purchase due to advances in display technology, the interactive system components, while still useful, are effectively rendered useless because of their relatively permanent association to the obsolete display. Hereinafter, solutions that include interactive systems that are integral with display units will be referred to generally as “all in one assemblies” unless indicated otherwise.

Solutions have been conceived to provide interactive systems that can be added on to existing flat panel displays to, in effect, retro-fit the displays so that the displays can be used in an interactive fashion. Here, for instance, a bracket assembly may be provided to hold an interactive unit adjacent a display surface edge where sensors are aligned along the surface to sense user activity adjacent the surface. Sensed activity is converted into commands to drive the display and hence provide functionality similar to that of the all in one assemblies.

While these retro-fit kits solve some of the problems associated with all in one interactive assemblies, known kits of this type, unfortunately, include bracket assemblies that are difficult to attach to existing display assemblies. For instance, in many cases retro-fitting bracket assemblies require holes to be formed in a display bezel to accommodate bracket screws or other mechanical fasteners. Here, additional display bezel holes are burdensome to create and often cause uncertainty as holes may have to be formed without knowing the internal structure of electronic components within the display housing/bezel. In addition, additional holes can destroy display appearance, especially if the interactive assembly is subsequently removed so that the display can be used alone. For instance, if additional mounting holes have to be formed in the front surface of a display bezel, the holes would severely affect appearance when the module is removed.

Moreover, where mounting holes have to be formed in the rear surface of a bezel, while the holes would be hidden from normal view, to make the holes and install the module, in most cases the display device would have to be removed from a supporting wall or other wall structure to access the space behind the display. Removal of a mounted display is generally considered disadvantageous and extremely burdensome.

In other cases, while hardware and associated mounting holes already required to mount a display to a wall or other supporting structure may be used to secure interactive assembly brackets to a display, the hardware and associated mounting holes are typically provided on a rear surface of the display in a hard to reach location or in a location that requires removal of the display from the supporting wall or structure to access. Removal of a mounted display is generally considered disadvantageous and extremely burdensome.

In addition, the flat panel industry has not developed widely accepted standards for placement of mounting holes and other structure on the rear surfaces of display units and therefore, whenever a new display configuration is developed, manufacturers that intend to use the holes and other structure for dual purposes (e.g., mounting of the display to a wall structure and mounting of other accessory components such as an interactive assembly to the display unit) have to change their mounting structure designs to accommodate new hole placement and mounting structure which increases costs of retro-fit mounting systems appreciably.

One other problem with known interactive mounting assemblies is that different mounting components are often required to accommodate displays that have different dimensions such as, for instance, different bezel thicknesses and different dimensions between bezel edges and existing mounting structure for mounting the display units to wall or other supporting structure. For instance, where two different display bezels may have thickness dimensions of 1 inch and 3.5 inches, different bracket components may be required to accommodate each of the different bezel thicknesses. As another instance, where two different displays include wall mounting brackets that extend from central locations of rear surfaces and a retro-fit configuration requires bracket components to extend down from the wall mounting brackets and around a lower edge of a display bezel to support an sensor module, if the first display has 12 inches between the wall mounting bracket and the lower bezel edge and the second display has 28 inches between the wall mounting bracket and the lower bezel edge, different bracket components between the wall mounting brackets and the lower bezel edges would likely be required. Different component requirements increase overall costs of bracket assemblies and therefore should be avoided when possible.

Thus, it would be advantageous to have a mounting assembly that allows a system installer to mount an sensor module to any of several different types of flat panel displays where the different displays have different dimensions. In addition, it would be advantageous to have a mounting assembly of the above kind wherein the assembly could be mounted to the display without requiring additional mounting holes and without requiring access to the rear surface of the display of a nature that requires an installer to remove the display from a supporting wall. Moreover, it would be advantageous to have a mounting assembly of the above type wherein adjustable components are easily accessible, where installation is easy and where removal of the sensor module is extremely easy and where, after an assembly is removed, the display unit is in the same condition it was in prior to installation of the mounting assembly.

### BRIEF SUMMARY OF THE INVENTION

It has been recognized that a simple mounting assembly that is suitable for mounting an sensor module can be configured such that an sensor module can be installed without requiring modification (e.g., holes) to a flat panel display bezel or housing and without requiring access to the rear surface of the display unit of a kind that would require removal of the display unit from a supporting wall structure. To this end, it has been recognized that adhesive can be used to mount at least some mechanical parts of a mounting assembly to a display unit bezel and that other mounting assembly components can then be mounted to the adhered components to such that hole forming and rear access to the display unit can be avoided.

In addition, it has been recognized that the adhesive used to mount the interactive unit may be selected to have properties such that the adhesive loses its adhesive effectiveness when mechanically disturbed such as via stretching. In this regard, for instance, an adhesive product manufactured by 3M and referred to as On Command Adhesive™ may be used as the adhesive for mounting components to the display unit bezel. In the case of On Command type adhesives, when the adhesive is compressed between two surfaces, the adhesive acts to strongly bond the surfaces together. However, when the adhesive is pulled along an axis, the adhesive loses its adhesive property and the two surfaces can be separated without causing damage to either of the surfaces. Here, the adhesive layers are arranged such that small pull tabs that are linked to the adhesive layers extend out from the surfaces mounted together so that the tabs are accessible. Then, after a sensor module is mounted to a bezel, when a user wants to remove the module so that the display device can be used without the module or so that the module can be remounted to some other display device, the user simply grasps the tabs and pulls thereby releasing the module. In some cases the module can be removed from intermediate mechanical components that are mounted via the adhesive to the bezel prior to deactivating the adhesive.

Moreover, it has been recognized that after at least some mounting components are mounted to a display unit bezel via adhesive, other components can be mounted and used to apply pressure to the bezel such that the forces on the adhesive layers are optimal for increasing adhesive properties of the adhesives. To this end, as well known adhesives can be loaded in three general ways. First, an adhesive can be loaded such that force applied thereto causes peeling (i.e., force pulls apart from one portion of the bond as opposed to across the entire surface area of the bond). Peel type loading results in a relatively weak bond between components. Second, an adhesive can be loaded such that a shear force is applied thereto (i.e., force is applied across the entire surface of the bond but along a trajectory parallel to the surfaces adhered together). Shear type loads result in a relatively strong bond between components when compared to the bond that occurs when peel type loading occurs. Third, an adhesive can be loaded such that a tension force is applied thereto (i.e., force is applied to pull surfaces bonded together apart along trajectories that are perpendicular to the bonded surfaces). Tension type loads result in the strongest type bonds between components. In at least some embodiments, mechanical mounting components are provided that cause tension loading on adhesive layers as opposed to peel loading thereby increasing the overall mounting effectiveness.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefor, to the claims herein for interpreting the scope of the invention.

### BRIEF DESCRIPTION OF THE SEVERAL VIEWS OF THE DRAWINGS

FIG. 1 is a perspective view of a flat panel display unit including an sensor module mounted thereto according to at least some aspects of the present invention:

FIG. 2 is a side plan view of the assembly of FIG. 1;

FIG. 3 is a perspective view of the sensor module of FIG. 1;

FIG. 4 is a schematic representation of several members that may be included in at least some sensor modules like the module of FIG. 3;

FIG. 5 is a perspective view of hinge members according to at least some aspects of the present invention;

FIG. 5A is a cross-sectional view taken along the line 5-5 of FIG. 5;

FIG. 6 is a perspective view of a mount strap according to at least some aspects of the present invention;

FIG. 7 is a cross-sectional view taken along the line 7-7 of FIG. 6;

FIG. 8 is a cross-sectional view taken along the line 8-8 of FIG. 6;

FIG. 9A is a side plan view of the bracket subassembly illustrated in FIG. 2;

FIG. 9B is similar to 9A, albeit illustrating the bracket subassembly in plan view from an opposite side;

FIG. 10 is a rear plan view of the bracket subassembly illustrated in FIG. 9A;

FIG. 11 is a rear plan view of the sensor assembly of FIG. 3;

FIG. 12 is a view similar to that of FIG. 2, albeit illustrating several of the assembly members in an exploded side plan view;

FIG. 13 is a perspective view of a portion of the display unit of FIG. 1 with one-half of a piano type hinge attached thereto;

FIG. 14 is a rear perspective view of the sensor module of FIG. 3;

FIG. 15 is similar to FIG. 12, albeit illustrating various assembly members in a relatively more assembled condition;

FIG. 16 is a sectional view similar to FIG. 15, albeit illustrating the assembly in yet a more assembled condition;

FIG. 17 is similar to FIG. 16, albeit with the assembly in still a more assembled condition;

FIG. 18 is similar to FIG. 17, albeit with the assembly in still a more assembled condition;

FIG. 19 is a rear perspective view showing the mounting assembly securing the sensor module to the display unit; and

FIG. 20 is a side plan view of another inventive embodiment wherein adhesive is solely employed to mount an sensor module to a display unit bezel.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

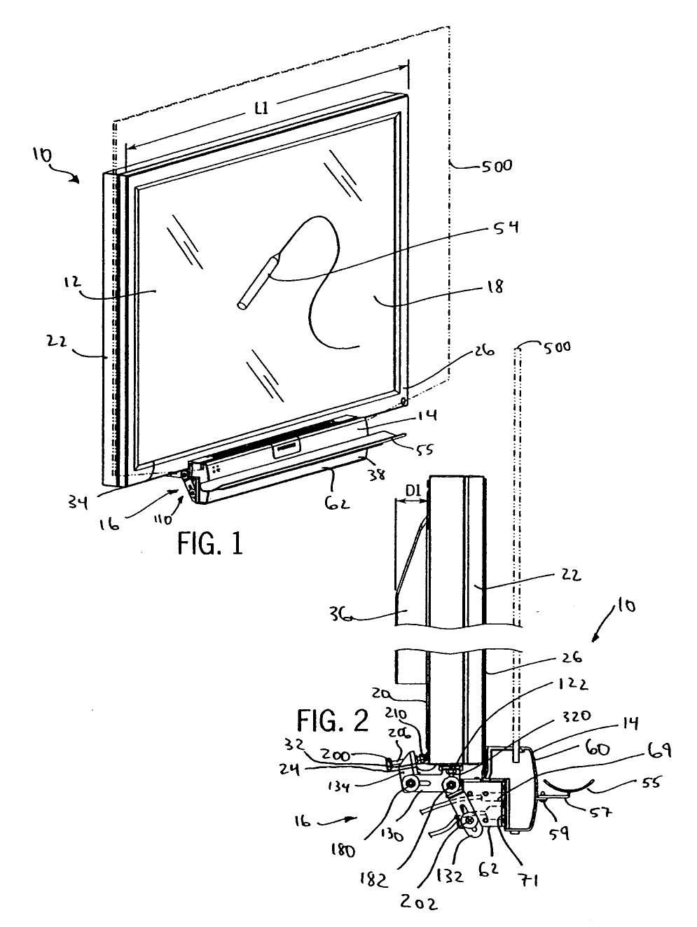

Referring now to the drawings wherein like reference numerals correspond to similar elements throughout the several views and, more specifically, referring to FIGS. 1 and 2, the present invention will be described in the context of an exemplary interactive flat screen assembly 10 that, in general, includes a flat screen display unit 12, an interactive/sensor module 14 and a mounting assembly generally identified by numeral 16. Display 12 may be any type of flat panel display including but not limited to a LCD or plasma flat screen display. In addition, it should be appreciated that, while the invention is described here in the context of an assembly 10 including a flat screen display, in at least some cases it is contemplated that the invention may be useable with other display types such as more conventional CRT type devices where the CRT has characteristics similar to those of a flat screen display for mounting purposes (e.g., a bezel that forms a lower lip having a thickness dimension suitable for mounting purposes). Moreover, the invention may also be used with rear or front projection display screens or projection form some other source. In most cases it is contemplated that sensor module 14 will be used with a relatively large flat screen assembly such as, for instance, a screen assembly that includes a viewing surface 18 having a diagonal dimension of anywhere between 15 and 200 inches.

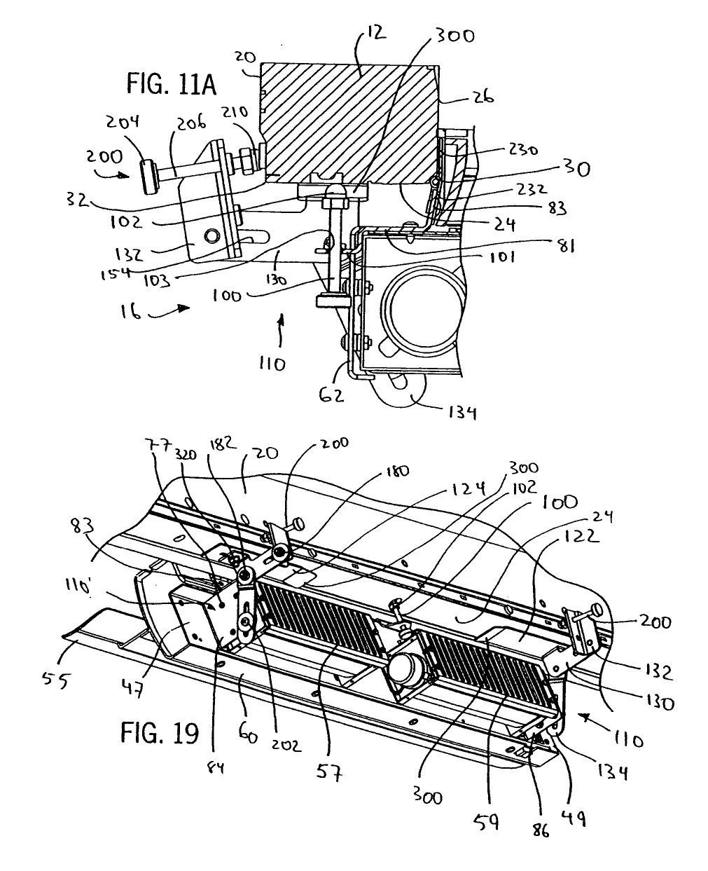

Referring once again to FIGS. 1 and 2, viewing surface 18 is mounted within a display housing including a display screen bezel/housing 22 that, in addition to other surfaces, forms a lower or bottom surface 24, a front surface 26 and a rear surface 20. Referring also to FIG. 11A, near a bottom portion of bezel 22, front surface 26 and bottom surface 24 form a lower front edge 30. Similarly, rear surface 20 and bottom surface 24 form a lower rear edge 32. Just above lower front edge 30, viewing surface 18 includes a bottom viewing surface edge 34 (see FIG. 1). Bezel 22 has a length dimension L1 between lateral surfaces of bezel 22 and the length of edge 34 is slightly less than dimension L1. Hereinafter, in at least some cases, the term “housing” is used to refer generally to a structure that forms the lower surfaces of a display unit and may, for instance, include a bezel or may include several surfaces that together form a housing structure.

Referring to FIG. 2, in at least some cases it is contemplated that display unit 12 will be mounted via a bracket 36 or the like to some type of support structure such as, for example, a permanent wall, a partition type wall, an easel structure, a shelving assembly, etc., ( not illustrated). Bracket 36 is mounted to rear surface 20 of bezel 22 and extends perpendicular therefrom a distance D1.

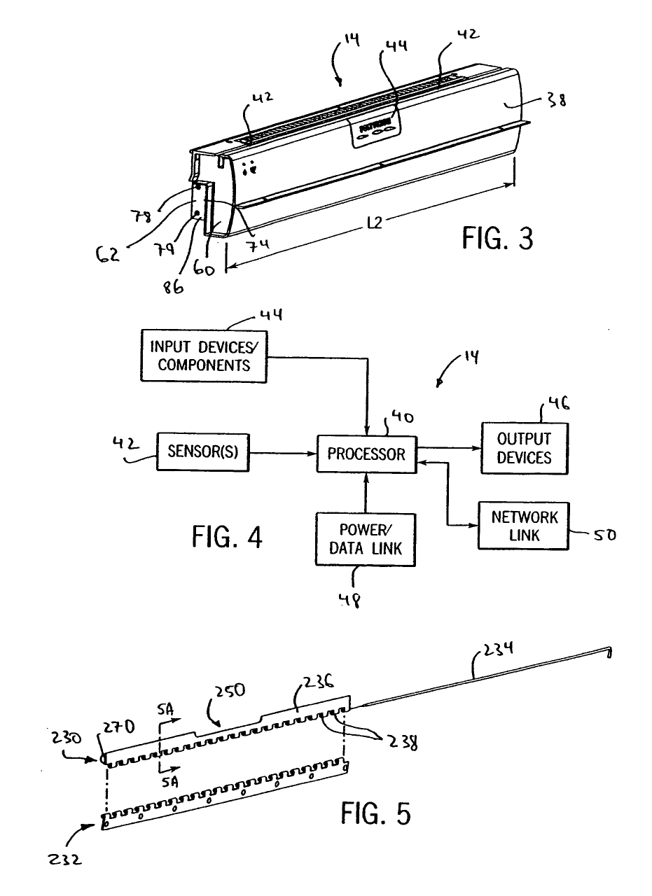

Referring still to FIGS. 1 and 2 and also to FIGS. 3 and 4, interactive/sensor module 14 includes a housing 38 and a plurality of members mounted therein or supported thereby. Housing 38 has a length dimension L2 that, in at least some cases, is less than length L1 of the lower edge of bezel 22. Although not illustrated, housing 38 may include a hinged front door or panel that can open by swinging, for example, downward, to expose an internal housing space for accessing various members housed therein or, for accessing storage space (not illustrated) located inside the housing 38.

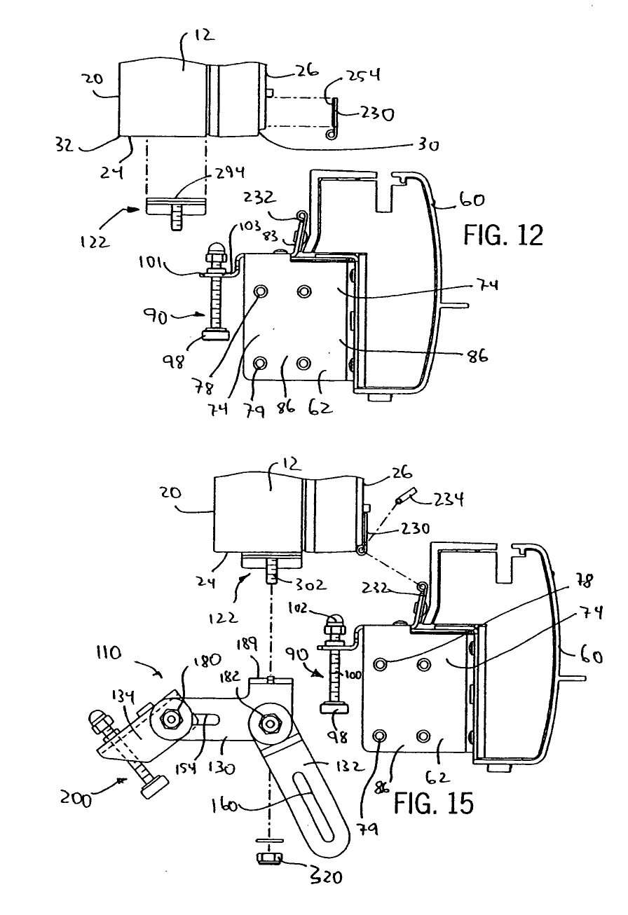

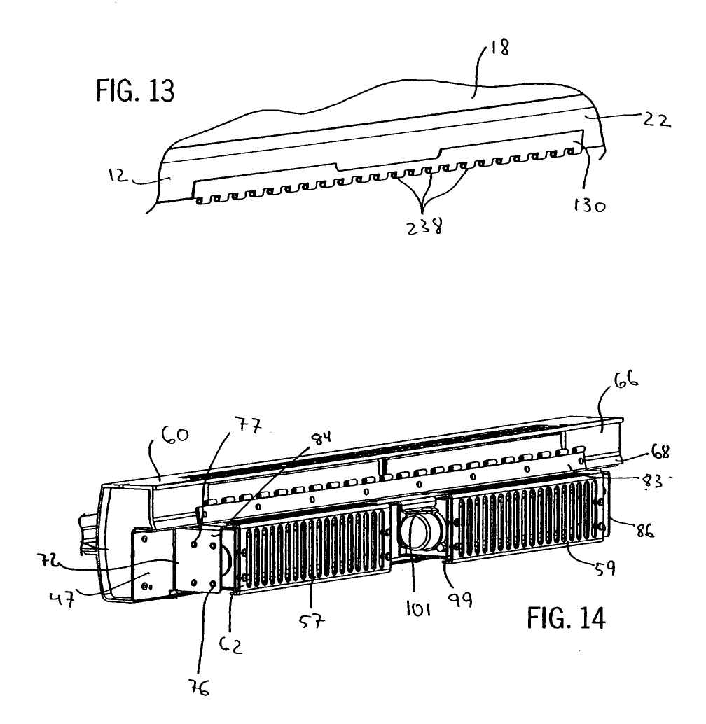

Referring still to FIGS. 1-3 and also to FIGS. 12 and 14, housing 38 includes a front housing assembly 60 and a rear enclosure 62 where enclosure 62 is mounted to a rear surface of front assembly 60 and where, in general, front assembly 60 extends at least in part upward from enclosure 62 so that a channel 64 is formed between an upper surface of rear enclosure 62 and a generally rearward facing surface (see 66 and 68) of front assembly 60. The rearward facing surface of front assembly 60 that resides above the top surface of rear enclosure 62 includes an upper surface section 66 extends generally along the length of housing 38 and a lower angled surface section 68 below section 66 that slopes rearward and toward rear enclosure 62 there below. Angled surface 68, like surface 66, extends generally along the length of housing 38. The angle formed between surfaces 66 and 68 is approximately 30 degrees although other angles are contemplated.

Referring still to FIGS. 12 and 14 and also to FIGS. 11 and 11A, enclosure 62 includes first and second lateral wall members 84 and 86 at opposite ends that form oppositely facing flat lateral surfaces 72 and 74, respectively, a top wall 81, an extension member 83, first and second rear wall members 57 and 59 and first and second lateral flange members 47 and 49. Top wall 81 substantially traverses the distance between lateral walls 84 and 86 and has a length dimension L3 that is similar to but nevertheless less than length dimension L2 of front assembly 60. Extension member 83 extends in a first direction from a front edge of top wall member 81 along the length of member 81 and is generally perpendicular (e.g., slightly angled forward—10 degrees from perpendicular) thereto.

Rear wall members 57 and 59 extend from an edge of top member 81 opposite the edge from which extension member 83 extends and extend in a direction generally opposite the direction in which member 83 extends and substantially perpendicular to top wall member 81. An opening or space 99 is provided between adjacent edges of rear wall members 57 and 59 to allow access to a screw assembly 90 described below. For instance, in at least some cases opening 99 will have a 3 or 4 inch length dimension so that an installer can place fingers therethrough generally unobstructed. Each of wall members 57 and 59 forms a plurality of slots (not labeled) that allow air flow for cooling purposes.

Referring still to FIG. 11, lateral wall members 84 and 86 are integrally formed with rear wall members 57 and 59, respectively, and extend forward therefrom and perpendicular thereto in the same direction that top wall member 81 extends and so that wall members 84 and 86 are also perpendicular to top wall member 81. Flange member 47 is integrally formed with lateral wall member 84 and extends perpendicular thereto and generally away from other lateral wall member 86. Similarly, flange member 49 is integrally formed with lateral wall member 86 and extends perpendicular thereto and generally away from other lateral wall member 84. Flange members 47 and 49 are mounted to a rear surface (not labeled) of front housing subassembly 60 via a plurality of screws so that enclosure 62 extends rearward therefrom as illustrated.

Surfaces 72 and 74 form threaded apertures. For instance, referring to FIGS. 14 and 15, in the illustrated embodiment, surface 72 forms four threaded apertures, two of which are labeled 78 and 79. Similarly, surface 74 forms four threaded apertures, two of which are labeled 76 and 77. In some cases it is contemplated that each of surfaces 72 and 74 may other numbers of apertures (e.g., two apertures), the number of apertures depending on capabilities of mounting assembly components to accommodate likely display unit dimensions.

Referring to FIGS. 11, 12 and 19, a rigid outcropping or fulcrum member 101 extends rearward from a central portion of top wall 81 and hence outcropping member 101 is generally aligned with opening 99 between rear wall members 57 and 59. A threaded aperture 103 is formed within outcropping member 101 that has an axis (not labeled) that is perpendicular thereto. When enclosure 62 is mounted below bottom surface 24 of display unit 12, upper wall 81 and outcropping member 101 are spaced below bottom surface 24.

Screw assembly 90 includes a head 98, a threaded adjusting shaft 100 and an end nut 102. Shaft 100 is sized and threaded to be receivable within threaded aperture 103. Nut 102 is a plastic (e.g., nylon) “acorn” nut (i.e., is generally acorn shaped) and is mounted at a distal end of shaft 100. Shaft 100 has a length dimension such that the shaft 100 may extend from a proximal end adjacent head 98, through threaded aperture 103 to the distal end where the distal end can be positioned above outcropping member 101 a distance greater than a dimension between top wall 81 and lower surface 24 of bezel 22 as illustrated in FIG. 11. Thus, when shaft 100 is rotated to drive the distal end of shaft 100 toward surface 24, the portion of shaft 100 (i.e., the separating portion) separating fulcrum member 101 from undersurface 24 is adjustable and eventually nut 102 is forced up against surface 24 (i.e., forced up against a bearing surface portion of surface 24) to apply pressure thereto. Assembly 90 cooperates with the mounting assembly 16 to secure module 14 to bezel 22 in a manner described below. Hereinafter, unless indicated otherwise, the term “screw” will be used in general to refer to assembly 90.

Before describing other members and assemblies below, it is noted that the function of screw 90 and outcropping member 101 may be provided via other configurations. For instance, in at least some cases it is contemplated that a bracket akin to outcropping member 101 may be mounted to a rear surface (not illustrated) of front housing assembly 60 (see again FIG. 14) where the bracket extends rearward and into the space formed by opening 99 where the rearward extending bracket would provide the same function as outcropping member 101 (i.e., the bracket would provide a bearing structure and a threaded aperture for receiving shaft 100

Referring to FIGS. 2 through 4, the members mounted within housing 38, in at least some embodiments, will include a processor 40, some types of sensing devices 42, input devices or members 44, output devices 46 and some type of power/data link 48. In FIGS. 2 and 11, the power and data links 48 are identified as outlets 71 and 69 for receiving power and data plugs (shown in phantom). In addition, in at least some cases, processor 40 may be linked to a network 50 (e.g., via data outlet 69) to facilitate remote control, monitoring and data transfer.

In general, the components within or supported by housing 38 are selected and configured or programmed to be able to sense when an assembly 10 user interacts or intends to interact with viewing surface 18 and then responds in some suitable fashion. For example, referring once again to FIG. 1, an assembly 10 user may want to make a mark or circle some information that is displayed via viewing surface 18 in order to highlight the displayed information. Here, in at least some cases, it is contemplated that a virtual pen 54 may be used to make the mark. Pen 54, in this case, includes a tip having characteristics such that information related to the location of the tip, when proximate or touching surface 18, can be sensed by the sensors in sensor module 14. When the sensors 42 sense presence of the pen 54 tip adjacent surface 18, the sensors provide the information to processor 40 which is programmed to use the obtained information to identify the position of the pen proximate surface 18 and to drive a display unit driver such that a line or curve is generated on surface 18 that follows pen tip movement. As another example, where selectable hyperlink text or icons are presented by a software program on surface 18, pen 54 may be used to select a selectable icon via placement of the pen tip on the icon. Many different types of interactive position sensing systems like the general system described above are known in the art and therefore details of such a system are not described here. Nevertheless, it should suffice to say that the present invention may be used with any type of position sensing system such as, systems that include infrared sensors, RF sensors, cameras, laser type sensors and any other type of position sensing configuration. In FIG. 3, exemplary sensors 42 are illustrated as being supported by a top wall of housing 38 so that, when module 14 is mounted adjacent lower edge 31 of display unit 12, the sensors face upward and obtain tip position information corresponding to pen 54 when pen 54 is used adjacent surface 18. Other instruments such as erasers, other pen types, etc., may be used with and sensed by sensors 42.

Referring still to FIGS. 2 through 4, in addition to providing software supported virtual icons via display surface 18 for selection via a pen 54 or the like, hardware type buttons may be provided in the form of an on/off switch 73 and/or a control panel 44. For instance, panel 44 may include buttons useable to cause a printer (not illustrated) linked to module 14 to print information currently displayed via surface 18, to archive currently displayed information, to e-mail displayed information, etc. As another example, where previous display screen shots have been archived, panel 44 buttons may be used to re-access the archived screen shots for further viewing, etc. Other panel functions are contemplated.

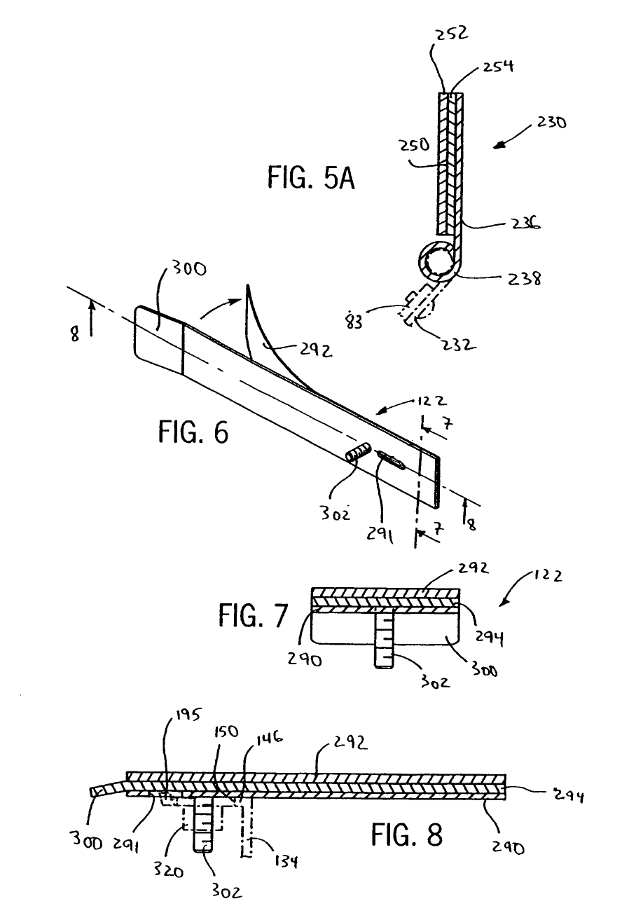

Referring once again to FIG. 2 and also to FIGS. 5 through 11 and FIG. 20, mounting assembly 16 includes first and second bracket subassemblies or couplers, each identified by numeral 110, a piano hinge assembly or coupler 112 and first and second under unit mount straps or couplers 122 and 124. The bracket subassemblies 110 have similar configurations and operate in a similar fashion and therefore only one of the assemblies will be describe here in detail. Similar components for subassemblies 110 throughout the figures are identified by similar numerals (e.g., member 130, member 132, etc., are labeled for each of the bracket assemblies 110). To this end, referring also to FIGS. 2, 9A, 9B and 10, subassembly 110 includes first, second and third bracket members or elements 130, 132 and 134, respectively, first and second threaded pivot members 111 and 113, first and second nuts 180 and 182, first and second washers 115 and 117, a thumb screw assembly 200 and a screw 202. While members 130, 132 and 134 may be formed using many different types of rigid material, in at least some cases each of members 130, 132 and 134 is made of bent rigid AWM sheet of a gauge that is sufficient to withstand force associated with the weight of module 14 when module 14 is supported thereby.

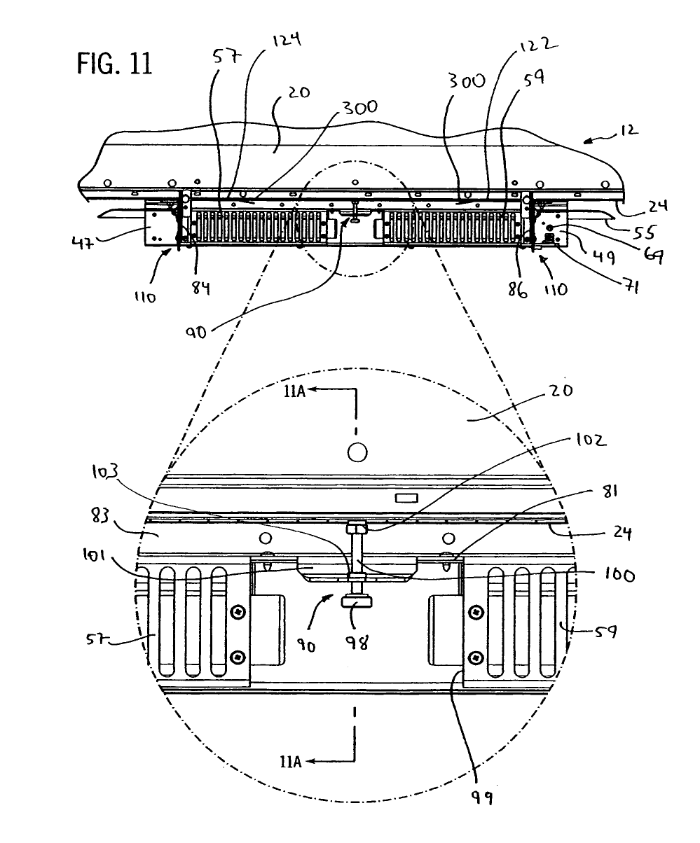

First member 130, as illustrated, is generally L-shapes including a first arm member 136 and a second arm member 138 that extend away from proximal ends linked at a central point 140 to distal ends 142 and 144, respectively. In at least some embodiments the angle between first and second members 136 and 138 is a right angle. Members 136 and 138 are coplanar. At distal end 142, member 136 includes an integrally formed member 146 that extends laterally to one side and perpendicular to member 136 and that forms a slot 150 that extends in the same direction that member 146 extends away from member 136 (i.e., extends perpendicular to the length of member 136). Member 146 forms a flat surface 189 facing away from member 136 and a slot aligning member 195 extends from the distal end of member 146 generally in the opposite direction in which member 136 extends from member 146 and parallel to member 136 (see specifically FIG. 10). At distal end 144, member 138 forms an elongated slot 154 that extends approximately half-way along the length of member 138. Member 130 forms a circular opening 137 at central point 140.

Referring still to FIGS. 2, 9A, 9B and 10, second member 132 is an elongated rigid member including proximal and distal ends 156 and 158. Member 132 forms a circular opening 167. In addition, member 132 forms a slot 160 that is approximately one-half the length of member 132 and that begins at distal end 158 and extends toward proximate end 156.

Third member 134 is an elongated rigid member having a proximal end 164 and a distal end 166. Member 134 forms a circular opening 169 at proximal end 164. At distal end 166, a flat lateral extension or fulcrum member 170 is integrally formed that extends perpendicular to the surface of member 134 from which it extends and that is generally parallel to the length of member 134. Member 170, in the illustrated embodiment, is flush with a lateral edge of member 134 as best illustrated in FIG. 10.

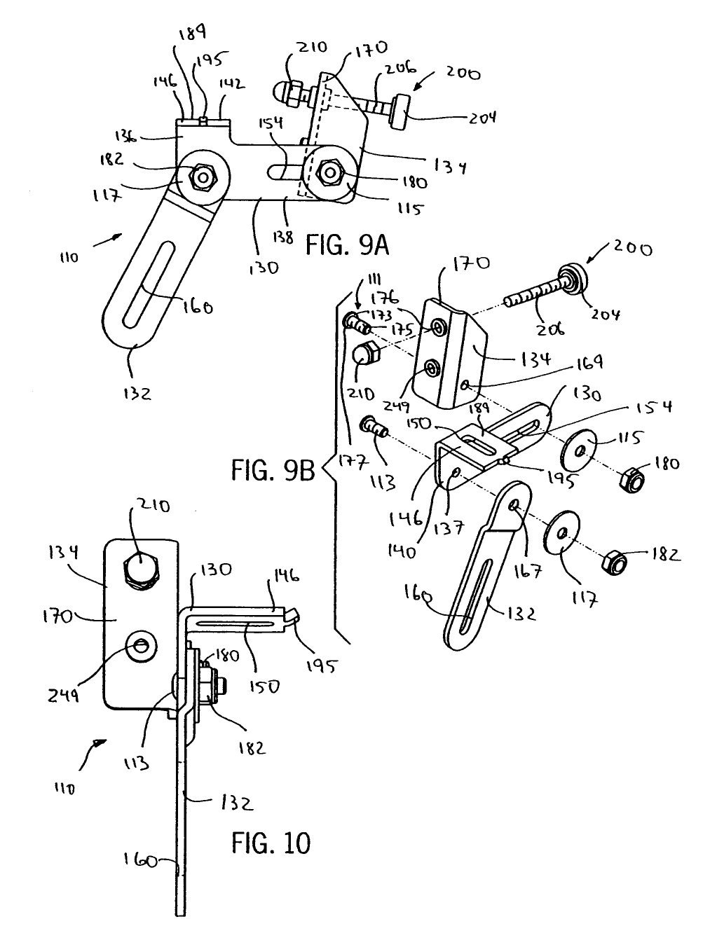

Referring still to FIGS. 9A and 9B, threaded members 111 and 113 are similar and therefore, in the interest of simplifying this explanation, only member 111 will be described here. Member 111 includes a head 173 and a threaded shaft 175 that extends from the head 173. Head 173 forms a bearing surface 177 adjacent shaft 175. Shaft 175 is dimensioned to pass through opening 169 and slot 154. Nuts 180 and 181 are threaded and dimensioned to be receivable on distal ends of the threaded shafts formed by members 111 and 113, respectively. When sub-assembly 110 is assembled, the threaded shaft 175 formed by member 111 passes through opening 169 and slot 154 as well as the opening formed by washer 115 and nut 180 is received on the distal end. Here, member 134 is mounted to member 130 so that fulcrum member 170 extends in a direction opposite member 146 (see FIG. 10). Similarly, when sub-assembly 110 is assembled, the threaded shaft formed by member 113 passes through openings 137 and 167 as well as the opening formed by washer 117 and nut 182 is received on the distal end.

After members 130, 132 and 134 and washers 115 and 117 are secured together via nuts 180 and 181 and members 111 and 113, when nut 180 is loosened, member 134 can rotate about the axis formed by shaft 175. In addition, when nut 180 is loosened, member 134 can slide along slot 154. When nut 182 is loosened, member 132 is generally released to rotate about the axis of the shaft formed by member 113. When either of nuts 180 or 182 is tightened, the relative positions of associated members 130 and 134 and members 130 and 132, respectively, is secured.

Referring to FIGS. 2, 3 and 16, screw assembly 200 includes a screw including a head member 204, a threaded adjusting shaft 206 and an acorn shaped plastic (e.g., nylon) nut 210 that forms a recess for receiving the distal end of shaft 206. Shaft 206 is threaded and dimensioned to be receivable within aperture 176 formed by lateral extension member 170 with a separating portion extending past member 170. In the illustrated embodiment a second aperture 249 is also formed by member 170 that is parallel to aperture 176. Here, an installer may select either of apertures 176 or 249 for receiving shaft 206, depending on bezel 22 dimensions. Screw 202 is threaded and dimensioned to be threadably receivable within either of apertures 78 or 79.

Referring now to FIGS. 5 and 5A, piano hinge 112 includes first and second hinge halves or couplers 230 and 232 and a hinge pin 234. Each of halves 230 and 232 is substantially similar and operates in a similar fashion and therefore, in the interest of simplifying this explanation, only first hinge half 230 will be described in detail. Half 230 includes an elongated rigid metal member 236 and a series of hinge eyelets, two of which are collectively identified by numeral 238. The eyelets 238 are equi-spaced along and extend along a lower edge thereof. Hinge pin 234 is an elongated rigid metal member that has a circular cross-section that is dimensioned so as to be received within eyelets 238 formed by hinge halves 230 and 232. To mount the hinge halves together, the eyelets formed by half 232 are placed between the eyelets 238 formed by half 230 so that the passageways formed thereby are aligned along the same axis. Thereafter, pin 234 is slid through the passageways formed by the eyelets to link the halves 230 and 232 together. Pin 234 is bent at one end to provide a handle for grasping after pin 234 has been placed in its operating position.

Referring now to FIG. 5A, a cross-section taken along the line 5A-5A of FIG. 5 is illustrated. In addition to showing member 236 of hinge half 230 and one of eyelets 238, the cross-section in FIG. 5A shows that a special type of adhesive product is provided in at least some embodiments on a rear surface 250 of hinge member 236. The adhesive product includes an adhesive layer 254 and a backing layer or sheet 252. Here, to attach member 236 to a surface, backing sheet 252 is removed to expose adhesive layer 254. Thereafter, the subassembly including member 236, and adhesive layer 254 is pressed up against the surface to which hinge half 230 is to be secured so that the exposed surface of adhesive layer 254 contacts the mounting surface.

In at least some embodiments, the special adhesive product 252 and 254 is selected such that the hinge half 230 can easily be removed. In this regard, it has been recognized that adhesive products are known that are particularly effective for adhesion purposes when left undisturbed but that lose their adhesive effectiveness when mechanically disturbed. For example, a product produced by 3M and referred to generally as On Command Adhesive™ is a double sided adhesive material where the adhesive works well not mechanically stressed but that has substantially reduced adhesive capabilities when the adhesive is stretched (e.g., pulled). In at least some embodiments it is contemplated that a double adhesive tape like the On Command Adhesive product will be used as the adhesive 254 to mount hinge half 230 to the front surface 26 of bezel 22 (see FIG. 2). Referring once again to FIGS. 5 and 5A, in at least some cases, a tab 270 is provided that extends from adhesive layer 254 that can be pulled to disturb adhesive layer 254 when an installer wishes to remove hinge half 230 from surface 26. Here, tab 270 extends laterally from a short edge of hinge half 230. In some embodiments it is contemplated that adhesive layer 254 will extend across the entire rear surface 250 of half 230 while in other embodiments small (e.g., 2-3 inch) sections of adhesive will be equi-spaced along rear surface 250. While tab 270 is only illustrated as extending form one end of half 230, in other embodiments a second tab 270 may extend from the other end of half 230 so that, to remove hinge half 230 from a mounting surface, the tabs can be pulled from both ends of the adhesive layer. In addition, in at least some cases it is contemplated that tabs (e.g., 4-5) may extend from the top or bottom edge of the adhesive layer 254 that can be pulled to loosen the adhesive layer for removal. Furthermore, in some cases no tabs 270 will be provided and instead, it will be presumed that when a hinge half 230 is to be removed from a mounting surface, a person removing the half will rely on a peel force to remove the hinge and adhesive layer. In general, On Command type adhesives and other adhesives having similar characteristics will be referred to herein as quick release adhesives.

Referring once again to FIG. 11, mount straps or couplers 122 and 124 are similarly constructed and operate in a similar fashion and therefore, in the interest in simplifying this explanation, unless indicated otherwise, only mount strap 122 will be described here in detail. Refer also to FIGS. 6, 7 and 8. Exemplary mount strap 122 includes a strap assembly 289, an adhesive layer 294 and a backing sheet 292. Assembly 289 includes a base member 290 and a threaded shaft 302 that is integrally formed therewith. Base member 290 is a rigid member formed of, for instance, plastic, sheet metal, etc. Member 290 forms a slot 291 part way along its length. Threaded shaft 302 is integrally connected to base member 290 (e.g., via a pressed in stud or in some other manner) and extends perpendicular therefrom to one side and adjacent slot 291. Adhesive layer 294 is applied to the side of base member 290 opposite shaft 302. Backing sheet 292 is placed on the side of adhesive layer 294 opposite central member base member 290. Here, as in the case of the dual sided On Command type adhesive described above with respect to FIG. 5A, in at least some cases an On Command type of dual sided adhesive tape is used as layer 294 such that base member 290 and shaft 302 can be mounted to a mounting surface and easily released when desired. To aid in releasing the adhesive layer, in the illustrated embodiment, a pull tab 300 is provided that extends from adhesive layer 294 along one short edge thereof.

Referring once again to FIGS. 5 and 14, second hinge half 232 is permanently secured to extension member 83 that extends upward from the top wall 81 of enclosure 62 with the hinge eyelets 238 proximate a top edge of member 83. Here, the term “permanent” is used to refer to the securing technique used to mount half 232 to member 83 to stress the fact that, in at least some applications, this mounting is different than the way in which half 230 is mounted to bezel 22. Thus, for instance, while half 230 is, in some embodiments, mounted to surface 26 of bezel 22 via an On Command type adhesive that can easily be released and removed, the mounting technique used to mount half 232 to member 83 would be of a relatively more permanent type such as, for instance, via a plurality of screws, rivets, a more permanent type adhesive, etc.

Next, an exemplary method for mounting sensor module 14 adjacent a lower edge 30 of display unit 12 that is consistent with at least some embodiments of the present invention is described. Initially, it will be assumed that second hinge half 232 is already secured to member 83 (see FIG. 14) and that bracket sub-assemblies including members 130, 132 and 134 and associated nuts 180 and 182, washers 115 and 117 and threaded members 111 and 113 as well as the screw assemblies 200 have been configured as illustrated in FIG. 9A. Here, prior to mounting any portion of sensor module 14 to bezel 22, all surfaces of bezel 22 to which adhesive is to be used to mount a component should be cleaned with alcohol or other types of cleaning swabs to ensure that all dirt and dust is removed and that a clean bonding surface is provided. Thus, for example, referring again to FIG. 2, the portion of front bezel surface 26 adjacent lower front edge 30 should be cleaned with an alcohol swab as should the bottom surface 24 sections of bezel 22 where straps 122 and 124 are to be adhered.

Referring to FIG. 1, an installer identifies the center of the display screen surface 18 to which sensor module 14 is to be mounted using a tape measure or the like. Here, if desired, the installer may place a small pencil mark along the lower edge 30 of bezel 22 to identify the display center.

Referring once again to FIGS. 5 and 5A, backing sheet 252 is removed from adhesive layer 254 on the rear surface 250 of hinge half 230. The center of hinge half 230 is aligned with the center of display surface 18 with hinge eyelets 238 aligned just below the lower edge 30 of bezel 22. The eyelets 238 should be aligned such that they are level with a floor there below and just below the bottom surface 24 of bezel 22. Adhesive layer 254 should be contacted to lower front edge 30 initially and should then be rotated upward until the entire exposed surface of adhesive layer 254 contacts front surface 26 of bezel 22. Hinge half 230 should be firmly pressed against surface 26 to force adhesive layer 256 to adhere thereto. At this point, hinge half 230 mounted adjacent lower front edge 30 of display unit 12 should appear as illustrated in FIG. 13.

While the adhesive layer 254 described above is described as being formed as a single adhesive layer member that extends along the length of hinge half 230, in at least some cases a plurality of smaller length adhesive strips may be equi-spaced along the length of member 236 to facilitate mounting of half 230 to surface 26.

Next, mount straps 122 and 124 are mounted to the undersurface 24 of bezel 22. To this end, referring once again to FIGS. 6 though 8 and also to FIG. 12, backing sheet 292 is removed from adhesive layer 294 to expose layer 294. As illustrated in FIG. 12, with the adhesive layer 294 exposed, strap 122 is pressed up against undersurface 24 firmly to attach strap 122 thereto. Similarly, mount strap 124 (see FIG. 11) is mounted to undersurface 24 by removing the backing layer from an adhesive layer and firmly pressing strap 124 up against undersurface 24. Here, it should be noted that the spacing between straps 122 and 124 and with respect to first hinge half 230 should be relatively precise to accommodate the specific dimensions of bezel 22. To this end, in at least some cases it is contemplated that positioning templates may be provided for an assembly installer that help the installer to precisely position straps 122 and 124. Referring to FIGS. 11 and 12, as shown, in at least some cases straps 122 and 124 are mounted so that adhesive tabs 300 extend toward each other.

Referring now to FIG. 15, after straps 122 and 124 and hinge half 230 have been secured to the mounting surfaces as described above, mounting bracket subassemblies 110 are mounted to the shafts of straps 122 and 124 that extend downward from undersurface 24. Referring also to FIG. 10, to mount one of subassemblies 110 to shaft 302, subassembly 110 is positioned such that slot 150 is aligned with shaft 302 and so that member 195 is aligned with slot 291 formed by base member 290 and with fulcrum members 170 extending toward each other in the same direction as tabs 300. With subassembly 110 so positioned, the components (e.g., nuts 180, 182, screws 200, 202, etc.) that have to be adjusted during installation and removal of module are all located where they can be accessed relatively easily below a side edge of display unit 12.

Continuing, subassembly 110 is moved upward so that shaft 302 passes through slot 150 and extension member 195 is received within slot 291 with top surface 189 of extension member 146 contacting the downward facing flat surface of base member 290 of mount strap 122 here, extension member 195 should restrict rotational motion of bracket member 130 about shaft 302. Next, a nut 320 is threaded on to the distal end of shaft 302 and tightened to secure member 146 and hence subassembly 110 to mount strap 122. Prior to tightening nut 320 completely, assembly 110 can be slid laterally with shaft 302 moving in slot 150 and extension member 195 moving within slot 291 until a desired position is achieved. At this point nuts 180 and 182 should be loose so that members 132 and 134 are generally free to move about with respect to member 130.

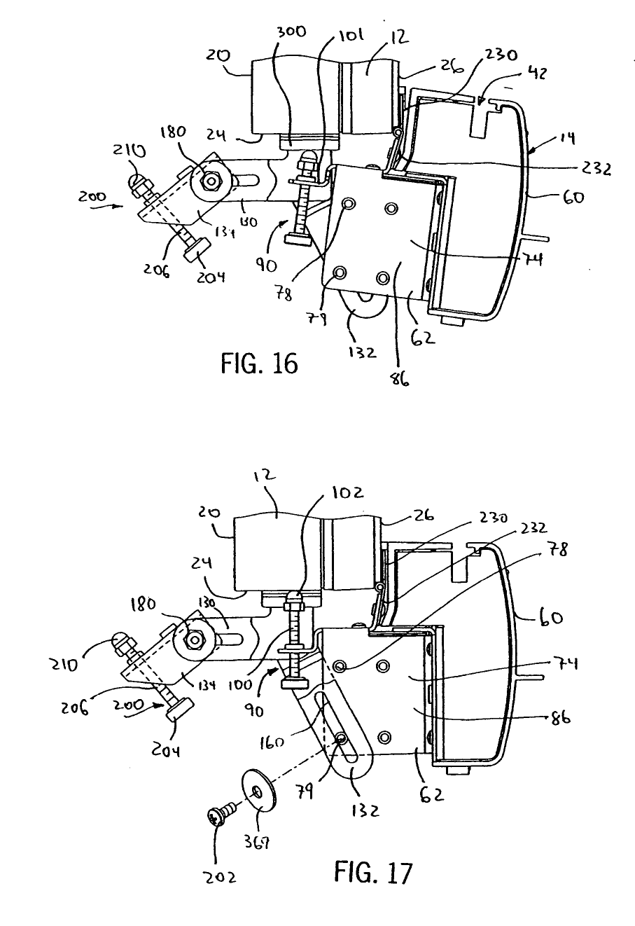

Sensor module 14 is next mounted by connecting second hinge half 232 (see FIG. 5) to first hinge half 230 and by connecting bracket members 132 (one form each of subassemblies 110) to enclosure members 82 and 84. To mount sensor module 14, first, referring to FIG. 15, module 14 is positioned so that the eyelets formed by second piano hinge half 232 are aligned with the eyelets formed by first piano hinge half 230. Hinge pin 234 is next slid through the aligned eyelets. At this point, sensor module 14 hangs generally below unit 12 and will reside generally between bracket subassemblies 110 as illustrated in FIG. 16. In addition, at this point, the weight of module 14 on first hinge half 230 applies a downward shear force on the adhesive layer 254 (see again FIG. 5A) that holds hinge half 230 to surface 26 and hence layer 254 provides a relatively strong bond.

Referring to FIGS. 11, 16 and 17, module 14 is next rotated about hinge pin 234 until a sensing plane 500 (i.e., a plane in which the sensors in module 14 operate) associated with the sensors included in module 14 is parallel with a plane formed by display surface 18. Once the sensing plane is parallel to display surface 18, thumb screw 90 is tightened until acorn nut 102 contacts undersurface 24 and screw 90 and nut 102 together maintain module 14 in the resulting position. Here, fine adjustments of the position of sensor module 14 with respect to unit 12 can be facilitated by rotating screw 90.

Referring to FIGS. 11 and 19, subassemblies 110 are moved along straps 122 and 124 to position the bracket subassemblies 110 adjacent enclosure members 84 and 86, respectively, after which nuts 320 are securely tightened to restrict further movement of bracket members 130 with respect to straps 122 and 124.

Referring to FIG. 17, one of screws 202 is fed through a washer 369 and through a slot 160 formed by member 132 of bracket subassembly 110 and is received within one of threaded apertures 78 and 79 formed by enclosure member 82. Here, the aperture 78 or 79 into which the screw 202 is received depends on the dimensions of bezel 22. In some cases aperture 78 will be more appropriate than aperture 79 and will allow more suitable overall adjustment. Which aperture 78 or 79 to use should be apparent to the installer and, where one aperture does not work properly the other aperture should be attempted. In a similar fashion a screw 202 and washer are used to secure a similar member of the second bracket sub-assembly 110 to a corresponding one of threaded apertures 76 and 77 (see FIG. 14). After screws 202 have been tightened, nuts 182 are tightened to maintain the positions of members 132 relative to adjacent bracket members 130. After screws 202 and nuts 182 are tightened, the position of module 14 with respect to unit 12 is secured (i.e., module 14 should be restricted from rotating about hinge pin 234).

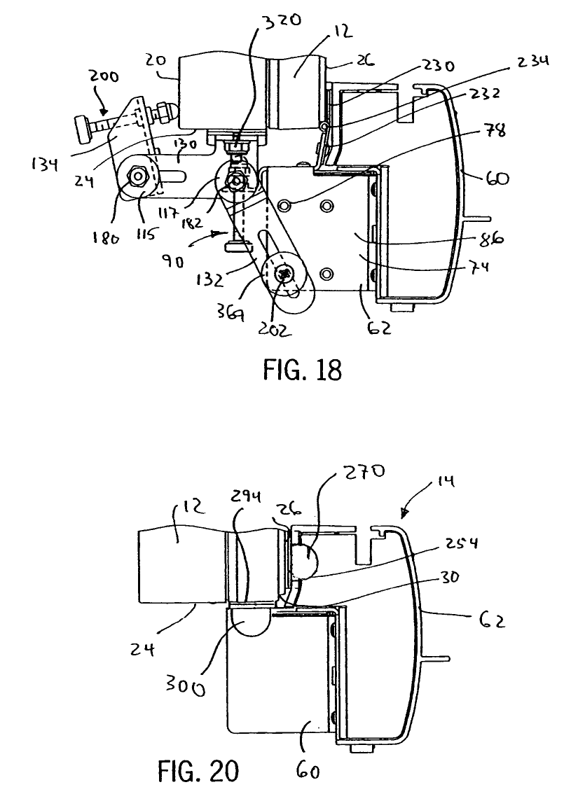

Referring to FIG. 18, third bracket members 134 on each of the bracket subassemblies 110 is rotated upward and adjusted until nut 210 on the distal ends thereof contacts the back surface 20 of bezel 22. Here, member 234 and screw 200 should be dimensioned so that they clear a mounting surface (not labeled) to which bracket 36 is mounted when member 234 and screw 200 are swung upward into operational positions. Screws 180 are tightened to secure members 134 to associated members 130 and then heads 204 are rotated until end members 210 place a slight pressure on a bearing portion (i.e., a bearing surface) of rear surface 20.

The force applied to rear surface 20 and undersurface 24 by screw 200 and screw 90, respectively, increase the magnitude of a tension force (i.e., forces perpendicular to the bonded surfaces of straps 122 and 124 and surface 24) applied to adhesive layers 294 holding straps 122 and 124 to undersurface 24 which increases the strength of the adhesive bond.

After installation, referring again to FIGS. 2 and 19, tabs 300 associated with straps 122 and 124 are hidden by sensor module 14 while each of nuts 180 and 182 as well as screws 200 and 202 are located to the sides of module 14 for easy access to adjust the mounting assembly.

To remove module 14 from display unit 12, referring again to FIGS. 2 and 18, screws 202 are first removed and then hinge pin 234 is pulled to release module 14 and expose hinge half 230 as well as strap tabs 300. Next, where adhesive tabs 270 are provided adjacent hinge half 230, the adhesive tabs 270 are pulled to release half 230 and tabs 300 on mount straps 122 and 124 are pulled to release straps 122 and 124. At this point all of the mounting assembly components will have been removed from unit 12 without causing any damage to bezel 22.

In at least some cases where one or more tabs 270 are provided that extend laterally from hinge half 230 (see again FIG. 5), the tabs 270 will be hidden by module 14 when module 14 is positioned in an operating position (see again FIG. 2). Here, when pin 234 is removed to release module 14, the tab(s) will be exposed to facilitate easy removal of hinge half 230. In other cases where tabs 270 are not provided, a user can remove hinge half 230 by applying a peel force starting at one edge of the adhesive and working along half 230 to the opposite edge of the adhesive.

Referring once again to FIGS. 1 and 2, in at least some cases tray mounting members 57 may be provided that extend from a front portion of housing assembly 60 and to which a tray subassembly 55 can be mounted via screws 59 or the like for receiving pens 54 and other interactive tools when not being used.

While the invention may be susceptible to various modifications and alternative forms, specific embodiments have been shown by way of example in the drawings and have been described in detail herein. However, it should be understood that the invention is not intended to be limited to the particular forms disclosed. For example, while a certain type of mechanical bracket subassembly 110 has been described above, other types of mechanical bracket assemblies are contemplated. For instance, other bracket assemblies may include only two bracket members (e.g., 130 and 134) where the bracket members have different shapes or, in the alternative, may include four or more bracket members that are arranged in some other different yet suitable fashion. As another example, while On Command type adhesives are desired for at least some applications, it is contemplated that other types of more permanent adhesives could be employed for attachment purposes. In addition, while the inventive system is described above in the context of an sensor module that mounts adjacent a lower surface 24 (see FIG. 2) of a display bezel, in at least some cases a similar configuration could be configured wherein a module 14 is mounted adjacent either one of the lateral surfaces of the bezel 22 or adjacent the top surface of the bezel. Moreover, as indicated above, the mounting assembly may be used with any of several different types of interfacing assembly/modules where the different types may employ any of several different types of technology to sense intended interactive display activity. In addition, the hinge first half 230 may be adhered to bezel undersurface 24 instead of to front surface 26 in at least some applications. Assembly 90 (see again FIG. 11) is optional in some applications while in others more than one assembly 90 may be provided to increase overall stability.

Furthermore, while the configuration described above includes both mechanical and adhesive type components, in at least some cases it is contemplated that only adhesive may be used to mount an sensor module 14 to a bezel. To this end, referring to FIG. 20, module 14 including housing assembly 60 and enclosure 62 are shown mounted adjacent lower front edge 30 via adhesive strips 254 and 294 where tabs 270 and 300 extend laterally adjacent housing 38 for easy access and removal of module 14. Similarly, in at least some cases less than the entire mounting structure described may be employed. For instance, while members 134 are desirable in at least some applications, in other applications such components may not be employed.

In addition, while the invention is described above as one wherein the bottom surface 24 of housing 22 is flat and perpendicular to front surface 26 and where rear surface 20 is parallel to front surface 26, it should be appreciated that the mounting assembly illustrated can accommodate bezels that include other relative angles. For instance, bottom surface 24 may, in some cases, not be completely horizontal and rear surface 20 may not be completely vertical but instead each may include some slight angle with respect to horizontal and vertical.

In addition, while the inventive mounting structure is described above in the context of mounting a sensor or interactive module 14, it should be appreciated that the mounting structure may be used in other applications to mount any type of display or board accessory adjacent an edge of a bezel or the like. For instance, in the case of a whiteboard or a chalk board, the assembly described above or any other assembly consistent with the teachings of this invention could be used to mount an accessory tray to a board edge or any other component.

Thus, the invention is to cover all modifications, equivalents, and alternatives falling within the spirit and scope of the invention as defined by the following appended claims.

To apprise the public of the scope of this invention, the following claims are made:

What is claimed is:

1. An apparatus for mounting a sensor module to a display unit including a housing wherein the housing forms at least a first mounting surface, the apparatus comprising:
a first coupler;
a first adhesive layer securing the first coupler to the first mounting surface; and
a second coupler linked to the sensor module and coupled to the first coupler wherein the second coupler is adjustable to modify the relative position of the sensor module to the display unit.

2. The apparatus of claim 1 wherein the adhesive layer is a quick release adhesive layer.

3. The apparatus of claim 2 wherein the adhesive layer includes a pull tab that extends therefrom that, when pulled, reduces the adhesiveness of the adhesive layer.

4. The apparatus of claim 1 further including a hinge pin wherein the first coupler includes a first hinge half and the second coupler includes a second hinge half and wherein the second coupler is coupled to the first coupler via the hinge pin.

5. The apparatus of claim 4 wherein the second hinge half is mechanically mounted to the sensor module.

6. The module of claim 4 wherein the housing includes a side surface adjacent the first mounting surface and separated from the first mounting surface by an edge, the first hinge half includes hinge eyelets and wherein the eyelets reside adjacent the edge.

7. The apparatus of claim 6 further including a fulcrum member and an adjusting shaft, the fulcrum member supported by the sensor module and supporting the shaft with a separating portion of the shaft extending between the fulcrum member and the side surface, the shaft adjustable with respect to the fulcrum member to alter the length of the separating portion.

8. The apparatus of claim 7 wherein the shaft is supported along an axis that is substantially perpendicular to the hinge pin.

9. The apparatus of claim 8 further including a third coupler, a second adhesive layer and a fourth coupler, the third coupler mounted to the side surface via the second adhesive layer and the fourth coupler linked at a first end to the third coupler with a second end of the fourth coupler supporting the sensor module.

10. The apparatus of claim 9 wherein the third coupler including a threaded shaft that extends away from the side surface and wherein the fourth coupler is secured to the shaft via a nut.

11. The apparatus of claim 10 wherein the fourth coupler is linked at the second end to the sensor module via a screw.

12. The apparatus of claim 11 wherein the fourth coupler includes a first bracket member secured at one end to the threaded shaft and a second bracket member secured at one end to the sensor module wherein the other ends of the first and second bracket members are mechanically linked.

13. The apparatus of claim 12 wherein the ends of the first and second bracket members that are mechanically linked are linked via a device that, when loose, allows the second bracket member to move with respect to the first bracket member and that, when tightened, locks the second bracket member with respect to the first bracket member.

14. The apparatus of claim 13 wherein the second bracket member is an elongated member and forms a slot along at least a portion of the second bracket member length and wherein the screw that secures the second bracket member to the sensor module passes through the slot and is received in a threaded aperture.

15. The apparatus of claim 1 wherein the first coupler includes a threaded shaft that extends from the mounting surface and the second coupler includes a bracket that is secured to the shaft via a nut.

16. The apparatus of claim 15 wherein the bracket includes a first bracket member secured at one end to the threaded shaft and a second bracket member secured at one end to the sensor module wherein the other ends of the first and second bracket members are mechanically linked.

17. The apparatus of claim 16 wherein the ends of the first and second bracket members that are mechanically linked are linked via a device that, when loose, allows the second bracket member to move with respect to the first bracket member and that, when tightened, locks the second bracket member with respect to the first bracket member.

18. The apparatus of claim 17 wherein the second bracket member is an elongated member and forms a slot along at least a portion of the second bracket member length and wherein the screw that secures the second bracket member to the sensor module passes through the slot and is received in a threaded aperture.

19. The apparatus of claim 18 wherein the display unit includes a display surface and wherein the first mounting surface is an undersurface of the display unit housing that is substantially perpendicular to display surface.

20. The apparatus of claim 16 further including a fulcrum member and an adjusting shaft, the fulcrum member supported by the sensor module and supporting the shaft with a separating portion of the shaft extending between the fulcrum member and a surface of the display unit housing, the shaft adjustable with respect to the fulcrum member to alter the length of the separating portion.

21. The apparatus of claim 20 wherein the bracket includes a third bracket member having a first end supported by the second bracket member and a second end that forms the fulcrum member.

22. The apparatus of claim 21 wherein the housing includes a bearing surface that is substantially perpendicular to the mounting surface and wherein the fulcrum member is positioned such that the separating portion of the shaft extends toward the housing surface.

23. The apparatus of claim 22 wherein the first mounting surface is an undersurface of the display unit housing and wherein the bearing surface is a rear surface of the display unit housing.

24. An apparatus for mounting a sensor module to a display unit including a housing wherein the housing forms at least a first mounting surface and a second surface, the apparatus comprising:
a coupler mounted to the sensor module;
a first adhesive layer securing the coupler to the first mounting surface;
a fulcrum member supported by the sensor module; and
an adjusting shaft supported by the fulcrum member and including a separating portion that extends from the fulcrum member to the second surface, the shaft adjustable with respect to the fulcrum member to alter the length of the separating portion.

25. The apparatus of claim 24 wherein the first mounting surface is a front surface of the housing and the second surface is one of a rear housing surface and an undersurface of the housing.

26. The apparatus of claim 24 wherein the first mounting surface is a portion of an undersurface of the housing and wherein the second surface is one of a portion of the undersurface of the housing and a rear surface of the housing.

27. The apparatus of claim 24 wherein the second surface is substantially perpendicular to the first mounting surface.

28. The apparatus of claim 24 wherein the second surface is parallel to the first mounting surface.

29. The apparatus of claim 24 wherein an axis of the adjusting shaft is substantially perpendicular to the adhesive layer.

30. The apparatus of claim 24 wherein the coupler includes a hinge.

31. The apparatus of claim 24 wherein the coupler includes a bracket.

32. An apparatus for mounting a sensor module to a display unit including a housing wherein the housing forms at least first and second mounting surfaces where the first and second mounting surfaces reside in non-parallel planes, the apparatus comprising:
first and second couplers mounted to the sensor module;
a first adhesive layer securing the first coupler to the first mounting surface; and
a second adhesive layer securing the second coupler to the second mounting surface.

33. The apparatus of claim 32 wherein the first and second mounting surfaces include a front display unit housing surface and an undersurface of the display unit housing.

34. The apparatus of claim 33 wherein the front surface and the undersurface are substantially perpendicular.

35. The apparatus of claim 32 further including a component that applies a force on the second coupler along a trajectory tending to separate the second coupler form the second mounting surface thereby increasing the magnitude of a tension force on the second adhesive layer.

36. A method for mounting a sensor module to a display unit including a housing wherein the housing forms a first surface and a second surface wherein the first and second surfaces are non-coplanar, the method comprising:
applying first and second adhesive layers to the first and second surfaces, respectively; and
mounting the sensor module to the housing via the first and second adhesive layers.

37. The method of claim 36 further including the step of applying a force between the sensor module and the housing along a trajectory having a component that is at least partially perpendicular to the one of the first and second adhesive layers thereby increasing the magnitude of a tension force on the one of the first and second adhesive layers.

38. The method of claim 37 wherein the first and second mounting surfaces are a front surface and an undersurface of the housing, respectively.

39. The method of claim 37 wherein the step of applying a force includes providing a fulcrum member that is supported by the sensor module and an adjusting shaft that is supported by the fulcrum member and that includes a separating portion between the fulcrum member and the housing and adjusting the shaft to alter the length of the separating portion.

40. The method of claim 39 wherein the step of mounting includes providing a hinge including first and second halves and a hinge pin where the second half is secured to the sensor module, mounting the first half to the first mounting surface via the first adhesive layer and connecting the first and second halves via the hinge pin.

41. The method of claim 40 wherein the display unit includes a display surface and the sensor module includes sensors that form a sensing plane, the method further including the step of using the fulcrum and adjusting shaft to support the sensor module in a position where the sensing plane is parallel to the display surface.

42. The apparatus of claim 41 wherein the first and second surfaces are a front surface and an undersurface of the housing, respectively.

43. The method of claim 40 wherein the step of mounting further includes mounting a coupler to the second mounting surface via the second adhesive layer, securing one end of a bracket to the coupler and securing another end of the bracket to the sensor module.

44. The apparatus of claim 43 wherein the coupler includes a threaded shaft and wherein the step of securing one end of the bracket to the coupler includes using a nut to secure one end of the bracket to the threaded shaft.

45. The method of claim 36 wherein the step of mounting includes mounting a first coupler to the first mounting surface via the first adhesive layer, mounting a second mounting coupler to the sensor module, mounting a third coupler to the second mounting surface via the second adhesive layer, securing a fourth mounting coupler to the third mounting coupler and securing the fourth mounting coupler to the sensor module.

46. The method of claim 19 further including the steps of adjusting the second and fourth couplers to adjust the position of the sensor module with respect to the display unit.

47. The method of claim 20 wherein the fourth mounting coupler includes a first bracket member and a second bracket member that is pivotally linked to the first bracket member by a locking member that, when locked, restricts relative motion of the first and second bracket members, the step of mounting the fourth coupler to the third coupler including mounting the second bracket member to the third coupler, the step of mounting the fourth coupler to the sensor module including mounting the second bracket member to the sensor module and the step of adjusting including adjusting the angle of the second bracket member with respect to the first bracket member and locking the second bracket member with respect to the first bracket member.
